(19) United States
(12) Patent Application Publication
(10) Pub. No.: US 2021/0167448 A1
(43) Pub. Date: Jun. 3, 2021

(54) SECONDARY BATTERY CELL AND SOLID-STATE STORAGE HAVING AN ACTUATOR

(71) Applicant: Helmut-Schmidt-Universitat / Universitat der Bunderswehr Hamburg, Hamburg (DE)

(72) Inventor: Detlef Schulz, Hamburg (DE)

(21) Appl. No.: 16/954,155

(22) PCT Filed: Dec. 13, 2018
(86) PCT No.: PCT/EP2018/084720

§ 371 Date: Jul. 14, 2020

(30) Foreign Application Priority Data
Dec. 13, 2017 (LU) LU100575

(51) Int. Cl. H01M 12/06; H01M 10/42; H01M 10/48; H01M 12/08

(52) U.S. Cl. CPC H01M 12/06; H01M 10/425; H01M 10/4242; H01M 12/08; H01M 10/48

(57) ABSTRACT

The disclosure relates to an apparatus configured as an electrochemical battery cell. The apparatus includes an anode, a cathode, and an electrolyte which is configured to allow ions to travel between the anode and the cathode. The apparatus further comprises an actuator. The actuator is configured to adjust a parameter of an electrochemical reaction in which the actuator and/or an actuated portion of the battery cell is chemically involved. Additionally or alternatively, the actuator and/or the actuated portion is a permeable portion of the battery cell which is configured to allow the ions to permeate into the permeable portion, wherein the actuator is configured to adjust an ion permeability of the permeable portion to the ions. The actuated portion of the battery cell is in operative interaction with the actuator. The disclosure also relates to an apparatus configured as a solid-state storage comprising an actuator configured to adjust a permeability of a permeable portion wherein the permeable portion is configured to allow a chemical species to permeate through.

### BACKGROUND

One of the most promising future battery technologies is the lithium-air (or lithium-oxygen) battery, which theoretically could provide 100 times as much power for a given weight compared to the currently leading technology, lithium-ion batteries. This could have a significant impact on battery-powered vehicles, which nowadays rely on lithium-ion batteries.

When a lithium-air battery discharges, lithium ions are formed at the anode which then move through the electrolyte toward the anode. The cathode is typically made of a porous carbon sponge material. At the interface between the carbon cathode and the electrolyte, electrochemical oxygen reduction occurs so that oxygen molecules receive electrons from the carbon material and then undergo chemical reactions with the lithium ions.

However, it has been shown that lithium-air batteries generally suffer degradation mechanisms that limit their life-cycle. Specifically, for present state of the art batteries it is impossible to recharge them more than a few times. For lithium-air batteries having an aprotic electrolyte, this resides, inter alia, in the fact that the carbon positive electrode becomes degraded. The degradation mechanism is commonly attributed to discharge products, in particular LiO₂ and Li₂O₂. These discharge products are insoluble in aprotic electrolytes and thereby clog the pores of the carbon cathode which prevents new oxygen molecules from being reduced. Although in Lithium-air batteries which have an aqueous electrolyte, the issue of cathode clogging is avoided, these batteries suffer from the drawback that the lithium metal reacts violently with water. Therefore, the aqueous design requires a solid electrolyte interface between the lithium and electrolyte

It has further been shown that also porous membranes as well as porous electrolytes of solid-state batteries get clogged during operation of the battery, thereby leading to reduced life-cycles and increased maintenance costs. Moreover, similar problems occur in reversible solid-state storage systems.

Therefore, a need exists for providing an improved solid-state storage or an improved electrochemical cell, in particular an improved metal-air electrochemical cell, having an increased life-cycle and/or reduced maintenance costs.

### SUMMARY

Embodiments provide an apparatus configured as an electrochemical battery cell. The apparatus includes an anode, a cathode, and an electrolyte which is configured to allow ions to travel between the anode and the cathode. The apparatus further comprises an actuator. The actuator is configured to adjust a parameter of an electrochemical reaction in which the actuator and/or an actuated portion of the battery cell is chemically involved. Additionally or alternatively, the actuator and/or the actuated portion is a permeable portion of the battery cell which is configured to allow the ions to permeate into the permeable portion, wherein the actuator is configured to adjust an ion permeability of the permeable portion to the ions. The actuated portion of the battery cell is in operative interaction with the actuator.

The electrochemical battery cell may be configured as an aqueous, aprotic, solid state or mixed aqueous/aprotic battery cell. The electrochemical battery cell may be rechargeable. For charging and/or discharging the electrochemical battery, the ions travel between the cathode and the anode. The ions may include cations and/or anions of one or more species. The electrochemical cell may be a metal-air electrochemical cell. Examples for metal-air electrochemical cells are lithium (Li)-air, sodium (Na)-air, potassium (K)-air, zinc (Zn)-air, magnesium (Mg)-air, and aluminum (Al)-air electrochemical cells. The actuator may be at least a portion of the anode, the cathode, the ion transport medium and/or the battery cell portion. The ion transport medium may be an electrolyte. The electrochemical reaction may be a reaction during the charging and/or the discharging cycle of the battery cell. The parameter of the electrochemical reaction may be a reaction rate of the electrochemical reaction.

According to an embodiment, the actuator is configured to desorb one or more adsorbed species. The adsorbed species may be adsorbed on the actuator and/or on the actuated portion. The parameter of the electrochemical reaction may be adjusted by causing the adsorbed species to desorb.

According to a further embodiment, the cathode, the anode, the ion transport medium and/or a separator membrane which is disposed in a flow path of the ions between the anode and the cathode comprise at least a portion of the actuated portion and/or the actuator. The anode may be a metal anode, in particular a lithium anode. The separator membrane may be an ion exchange membrane for the ions. At least one side of the separator membrane may be in contact with the electrolyte. Alternatively, the separator membrane may be configured to separate the anode or the cathode from the electrolyte.

According to an embodiment, the permeable portion comprises a porous material. The ion permeability of the permeable portion may be at least partially provided by pores of the porous material. The porous material may be, for example, porous carbon. The porosity of the cathode may store solid products generated from the reaction of the metal ions of the anode with 0₂, such as metal superoxide or metal peroxide during the discharges cycle of the battery. Examples of such species are Li₂O and an Li₂O₂.

According to an embodiment, the permeable portion is at least a portion of the cathode which is configured as a gas diffusion cathode, in particular as an air diffusion cathode. The gas diffusion cathode may include a substrate, such as carbon, in particular porous carbon.

According to a further embodiment, the ion permeable portion comprises a plurality of channels. A permeability of the channels determine the permeability of the permeable portion.

According to an embodiment, the actuator is configured to adjust the ion permeability by physically modifying at least a portion of the channels.

According to a further embodiment, the actuator is configured to interact with one or more adsorbed and/or entrapped species within the channels for adjusting a chemical reaction activity within the channels. By way of example, the actuator may be configured to generate an electric and/or magnetic field and/or to generate an electric current for performing the interaction with the one or more adsorbed and/or entrapped species. Additionally or alternatively, the actuator may be configured to couple acoustic energy into the permeable portion and/or to exert a mechanic, hydrodynamic and/or aerodynamic force for performing the interaction with the one or more adsorbed and/or entrapped species.

According to a further embodiment, the actuator and/or the actuated portion is at least a portion of the anode. The actuator may configured to desorb adsorbates from the anode and/or to prevent or reduce corrosion of the anode. By way of example, the anode is a lithium (Li) anode. The adsorbates may be physisorbed and/or chemisorbed.

According to a further embodiment, the apparatus further comprises a controller and a sensor system. The sensor system may be configured to measure an operational parameter of the battery cell. The actuator may be controlled by the controller depending on sensor output of the sensor system. The actuator may be controlled during charging and/or discharging cycles of the electrochemical battery cell.

According to an embodiment, the sensor is configured for measurement of a density of a species of charge carriers and/or a combined density of a plurality of species of charge carriers. Additionally or alternatively, the sensor may be configured for measurement of a flux density of a species of charge carriers and/or a combined density of a plurality of charge carriers.

According to a further embodiment, sensor system is configured for measurement of a charge density and/or a charge flux density within the electrolyte.

According to a further embodiment, the sensor system includes a resistive sensor, a capacitive sensor and/or a potentiometric sensor. The potentiometric sensor may include a surface which includes lead (Pb), zinc (Zn) and/or vanadium (V).

According to a further embodiment, the sensor is configured to measure one or a combination of a current of the battery cell, a voltage of the battery cell, a temperature, an internal resistance and/or a battery capacity of the battery cell.

According to a further embodiment, the actuator is configured to generate an electric field, a magnetic field and/or an electric current which adjust the parameter of the electrochemical reaction and/or the permeability. The actuator may include one or more electrodes and/or coils for generating the electric field, magnetic field and/or the electric current. The electric field, magnetic field and/or electric current may be configured to interact with adsorbates, in particular with adsorbates in channels or pores of the permeable portion. The interaction of the electric field, the magnetic field and/or electric current with the adsorbates may be configured so that the interaction causes the adsorbates to desorb.

According to a further embodiment, the electric and/or magnetic field is a constant, or time-varying electric and/or magnetic field. The time-varying electric and/or magnetic field may be a pulsed or oscillatory electric and/or magnetic field. At least a portion of the electric and/or magnetic field may pass through the actuated portion, in particular through the permeable portion. According to a further embodiment, the electric current is a constant or time-varying electric current. The time-varying electric current may be a pulsed or oscillating electric current. At least a portion of the electric current may pass through the actuated portion, in particular through the permeable portion.

According to a further embodiment, the actuator comprises one or more mechanical transducers for coupling acoustic energy into the actuated portion of the battery cell, such as the permeable portion. The mechanical transducer may be an electromechanical transducer. The electromagnetic transducer may include a piezo-active material.

According to a further embodiment, the actuator is configured to exert a mechanic, hydrodynamic and/or aerodynamic force on the actuated portion, in particular on the permeable portion. By way of example, the actuator includes one or more inlets for introducing gas or liquid into the battery cell, in particular into the cathode, the anode, the ion transport medium and/or the separator membrane which is disposed in at flow path of the ions between the cathode and the anode.

According to the embodiment, the permeable portion has micro-sized pores, meso-sized pores and/or macro-sized pores. Micro-sized pores may be defined as pores having a diameter of less than 2 nanometers. Meso-sized pores may be defined as pores having a diameter in the range of between 2 and 50 nanometers. Macro-sized pores may be defined as pores having a diameter of more than 50 nanometers. The micro-sized pores may have a diameter greater than 0.5 nanometer or greater than 1 nanometer. The macro-sized pores may have a diameter of less than 10 micrometers or less than 1 micrometer or less than 500 nanometers.

Embodiments provide an apparatus configured as a solid-state storage for a chemical species to be stored. The solid-state storage comprises a permeable portion which is configured to allow at least one storable chemical species to permeate into the permeable portion for storing or retrieving the storable chemical species in the solid-state storage. The solid-state storage further comprises an actuator which is in operative interaction with the permeable portion for adjusting an ion permeability of the permeable portion to the ions.

The solid-state storage may be a reversible stolid-state storage. The permeable portion may be at least a portion of a storage medium in which the storable chemical species is stored. The chemical species to be stored may be, for example, hydrogen. The chemical species to be stored may be in a gaseous, liquid or vapor state.

According to a further embodiment, the permeable portion includes porous material. A permeability of the permeable portion to the chemical species to be stored may be at least partially provided by pores of the porous material.

According to a further embodiment, the permeable portion comprises a plurality of channels. A permeability of the channels may at least partially determine the permeability of the permeable portion to the chemical species to be stored.

According to a further embodiment, the actuator is configured to adjust the permeability by physically modifying at least a portion of the channels for performing the adjustment of the permeability of the permeable portion to the chemical species to be stored.

According to a further embodiment, the actuator is configured to interact with one or more adsorbed and/or entrapped species within the channels for adjusting a permeability of the permeable portion to the chemical species to be stored.

According to a further embodiment, the apparatus further comprises a controller and a sensor system. The sensor system may be configured to measure an operational parameter of the solid-state storage. The actuator may be controlled by the controller depending on sensor output of the sensor system.

According to an embodiment, the sensor is configured for measurement of a density or a flux density of the species to be stored.

According to a further embodiment, the actuator is configured to generate an electric and/or magnetic field. The electric and/or magnetic field may penetrate into the permeable portion.

According to an embodiment, the actuator comprises one or more mechanical transducers for coupling acoustic energy into the permeable portion.

According to an embodiment, the actuator is configured to exert a mechanic, hydrodynamic and/or aerodynamic force on the permeable portion.

Embodiments of the present disclosure provide an electrochemical battery cell including an anode, a cathode and an electrolyte configured to allow ions to travel between the anode and the cathode. The electrochemical battery cell further includes an actuator which is in operative interaction with the electrolyte and configured to adjust a density distribution for each of one or more species contained in the electrolyte.

According to an embodiment, the actuator is configured to adjust the density distribution using an electric field, magnetic field and/or current. The electric field, magnetic field and/or current may be constant or time-varying. The time-varying electric field, magnetic field and/or current may be pulsed or oscillatory.

According to a further embodiment, the actuator is configured to adjust the density distribution using mechanical transducers which are configured to couple acoustic energy into the electrolyte.

According to a further embodiment, the actuator is configured to adjust the density distribution using a mechanic, hydrodynamic and/or aerodynamic force which is exerted on the electrolyte using the actuator.

### BRIEF DESCRIPTION OF THE FIGURES

The detailed description of some exemplary embodiments is made below with reference to the accompanying figures, wherein like numerals represent corresponding parts of the figures.

FIG. 1A shows a schematic view of a battery cell according to a first exemplary embodiment;

FIGS. 1B shows alternative configurations for the sensor electrodes in the battery cell of the first exemplary embodiment which is illustrated in FIG. 1;

FIGS. 1C to 1F show alternative configurations for the actuator and the sensor electrode arrangement in the first exemplary embodiment shown in FIG. 1;

FIG. 1G to 1K show further alternative configurations for the actuator in the first exemplary embodiment shown in FIG. 1;

FIG. 2A is a schematic view of a battery cell according to a second exemplary embodiment;

FIG. 2B is a schematic view of a battery cell according to a third exemplary embodiment;

FIG. 2C is a schematic view of a battery cell according to a fourth exemplary embodiment;

FIG. 3A is a schematic view of the actuator interacting with the permeable portion in the battery cell according to the first to fourth exemplary embodiments, shown in FIGS. 1 to 2c;

FIG. 3B is a schematic view of an actuator of a battery cell according to a fifth exemplary embodiment;

FIG. 3C is a schematic view of an actuator of a battery cell according to a sixth exemplary embodiment;

FIG. 3D is a schematic view of an actuator of a battery cell according to a seventh exemplary embodiment;

FIG. 4A is a schematic view of a battery cell according to a eighth exemplary embodiment;

FIG. 4B is a schematic view of a battery cell according to a ninth exemplary embodiment;

FIGS. 4C shows an exemplary configurations of an inlet member of the actuator in the battery cell according to the ninth exemplary embodiment, as shown in FIG. 4B;

FIG. 4D shows a further exemplary configurations of an inlet member of the actuator in the battery cell according to the ninth exemplary embodiment, as shown in FIG. 4B;

FIG. 5A is a schematic view of a battery cell according to a tenth exemplary embodiment;

FIG. 5B shows an exemplary configuration of a transduction member of the actuator in the battery cell according to the tenth exemplary embodiment, as shown in FIG. 5A;

FIG. 6A is a schematic illustration of a reversible solid-state storage according to an exemplary embodiment; and

FIG. 6B is a further schematic illustration of the reversible solid-state storage according to the alternative exemplary embodiment.

### Detailed description of exemplary embodiments

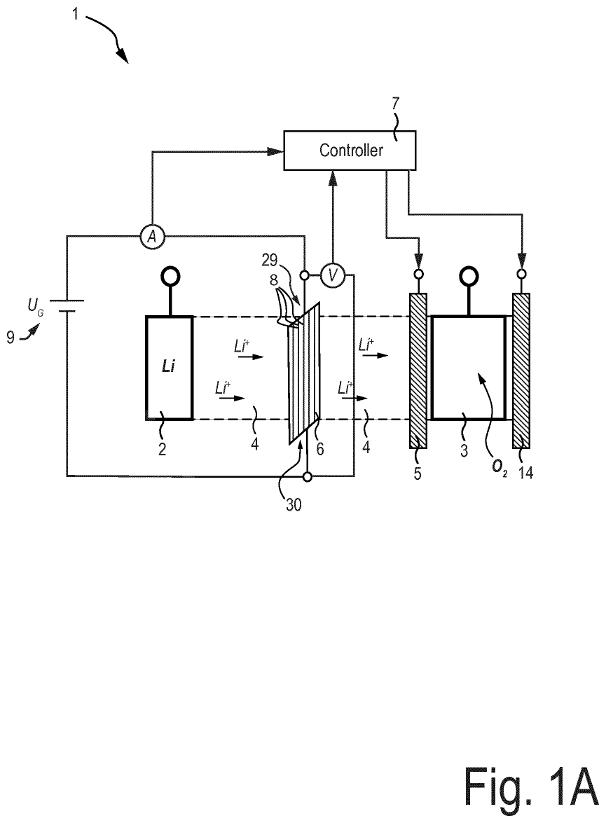

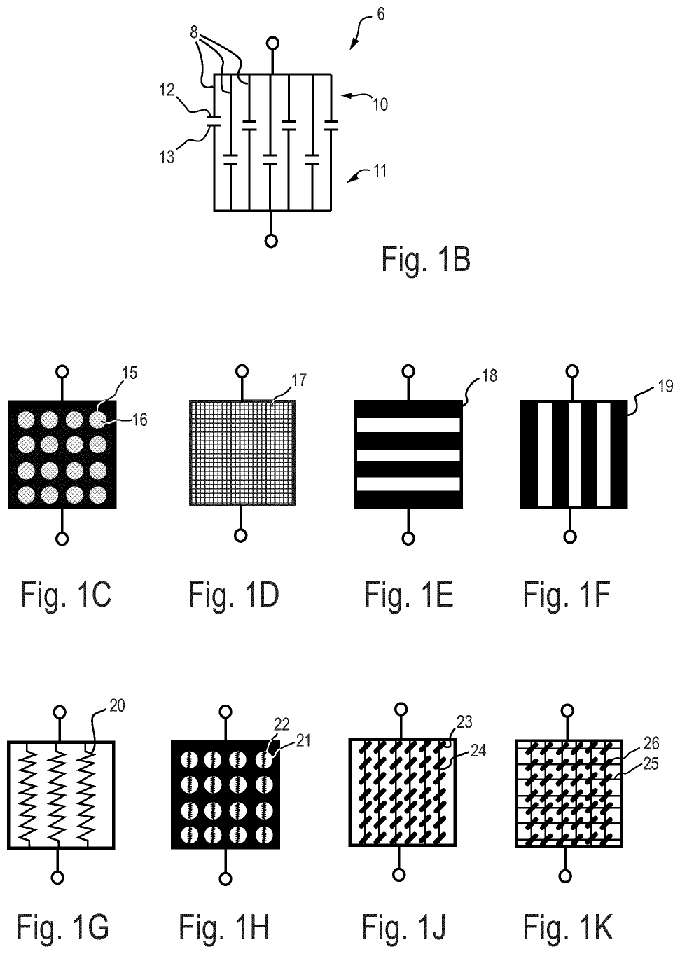

FIG. 1A shows an electrochemical battery cell 1 according to a first exemplary embodiment. The electrochemical battery cell 1 is configured as a lithium (Li)-air battery cell. However, it is noted that it is also possible to obtain the technical effects and advantages described herein in connection with the embodiment of FIG. 1A in other battery systems, in particular in other metal-air battery sells, such as sodium (Na)-air, potassium (K)-air, zinc (Zn)-air, magnesium (Mg)-air, and aluminum (Al)-air electrochemical cells or in fuel cells.

The electrochemical battery cell 1 includes an anode 2, a cathode 3 and an electrolyte 4. During the discharging cycle of the electrochemical battery cell 1, lithium ions travel from the anode 2 through the electrolyte 4 toward the cathode 3 and during the charging cycle, lithium ions travel from the cathode 3 through the electrolyte 4 toward the anode 2.

In the exemplary embodiment, which is shown in FIG. 1, the cathode 3 is a gas diffusion cathode which is configured so as to allow air to diffuse into its interior. Thereby, during the battery's discharging cycle, oxygen reacts inside the gas diffusion cathode with lithium ions provided by the anode. Hence, the cathode 3 represents a permeable portion of the electrochemical battery cell 1 which is configured to allow the lithium ions and the oxygen to permeate into its interior.

The cathode 3 may include a catalyst. The catalyst may be provided no a reactive surface of the cathode, in particular within the pores of a porous cathode substrate. By way of example, the catalyst may include one or a combination of Pt, MnO₂, and Au. Additionally or alternatively, the carbon substrate may be passivated by a passivation coating. The passivation coating may include Al₂O₃ and/or FeOₓ.

For conventional aprotic metal-air electrochemical cells which rely on gas diffusion cathodes, it has been shown that the reactions inside the cathode lead to a degradation mechanism that limits the life cycle of the electrochemical battery cell 1. This resides, inter-alia, in the fact that discharge products which are generated during the battery's discharge cycle such as LiO₂ and Li₂O₂ clump inside the pores of the carbon electrode, thereby, obstructing the oxygen-diffusion pathways.

However, it has further been shown, that it is possible to improve the battery cell's life cycle by providing at least one actuator which is in operative interaction with the cathode and/or the adsorbates which clump together inside the pores of the cathode. The operative interaction is configured so as to cause the discharge products which are adsorbed inside the pores to desorb from the cathode. This increases the reaction rate of the electrochemical reaction between the lithium ions and oxygen.

Accordingly, in the exemplary embodiment of FIG. 1A, two actuators 5 and 14 are provided so that the cathode 8 is disposed between the actuators 5 and 14. The operative interaction of the actuators 5 and 14 with the cathode allows adjustment of the permeability of the permeable cathode 3 to the lithium ions and to the oxygen. The exemplary embodiment of FIG. 1 is provided with two actuators 5 and 14. However, it is also conceivable that the battery cell 1 only has a single actuator or has more than two actuators.

Each of the actuators 5 and 14 includes one or more electrodes for generating an electric field which penetrates into the pores of the cathode 3. The electric field may be a continuous or time-varying electric field. The time-varying electric field may be a pulsed or an oscillating electric field. Exemplary configurations for the actuators 5 and 14 will be discussed further below.

The operation of the actuators 5 and 14 is controlled by a controller 7, which is in signal communication with a sensor system 6. The controller 7 is configured to control the actuators 5 and 6 depending on a sensor output generated by the sensor system 6. It has been shown that this allows efficient interaction of the actuators 5, 14 with the cathode 3. However, it is also conceivable that the battery cell's life cycle can be increased by using one or more actuators without relying on a sensor system and a controller.

In the exemplary embodiment of FIG. 1, the sensor system 6 is configured to measure a charge density within the electrolyte 4 using an electrode arrangement. As is illustrated in FIG. 1A, the electrode arrangement includes a plurality of longitudinal electrodes 8, each of which extending inclined relative to a flow direction of the lithium ions within the electrolyte 4. Each of the electrodes 8 is connected at a first longitudinal end thereof to a first connecting portion of the electrode arrangement and at a second longitudinal end thereof to a second connecting portion of the electrode arrangement. Thereby, the electrode arrangement has two ends 29 and 30 which are connected by the electrodes 8. Both ends 29 and 30 of the electrode arrangement are connected to a voltage source 9 of the battery cell 1. The controller 7 is configured to measure a resistance and/or a change of the resistance between the ends 29 and 30.

It has been shown that the resistance measured between the ends 29 and 30 of the electrode arrangement depends on the charge density of the electrolyte which is present between the longitudinal electrodes 8. An increase in the measured resistance indicates a decrease in charge density, which, in turn, may indicate a clogged cathode. Upon detecting a high resistance and/or an increase in the resistance, the controller controls the actuators 5 and 14 to increase a level of interaction of the actuators 5 and 14 with the cathode 3 and/or the adsorbates within the cathode 3 to cause at least a portion of the adsorbates to desorb from within the cathode 3.

Using the actuators 5 and 14 in conjunction with the battery cell 1 has several further technical advantages. Using the controllers 5 and 14, it is possible to control the movement of the charge carriers in the electrolyte. Furthermore, the actuators 5 and 14 can be used to stop the battery's charging and/or discharging cycle. Thereby, it is possible to provide short circuit protection for the battery cell. Furthermore, it is possible to increase the battery's power for a short period of time. Thereby, it is possible to use batteries of smaller dimensions can be used which are lighter in weight. Moreover, using the actuators 5 and 6, it is possible to provide a fast shutdown for the battery, which allows protection if the battery is under high load for a long period of time. Thereby, the battery is protected against overload and fire.

FIG. 1B shows an alternative configuration for the electrode arrangement of the sensor system 6. In the configuration of FIG. 1B, the electrode arrangement is configured as a comb capacitor which includes a pair of comb electrodes 10 and 11. The comb electrodes 10 and 11 are arranged so that their teeth are inter-meshed but not touching. Each longitudinal end of the comb electrodes 10 and 11 include transverse portions 12 and 13 which are oriented substantially perpendicular to a longitudinal axis of the respective tooth so that the transverse portions 12 and 13 of opposite longitudinal ends extend substantially parallel relative to each other. The transverse portions 12 and 13 may be configured as plates or as bars. It has been shown that the transverse portions 12 and 13 increase the sensitivity of the comb capacitor.

It has been shown that also for this configuration, a resistance measured between the comb electrodes 10 and 11 depends on the charge density of the electrolyte which is present between the comb electrodes 10 and 11.

Both sensor systems which are described in connection with FIGS. 1A and 1B represent resistive sensors. Additionally or alternatively the sensor system may include one or more capacitive sensors and/or one or more potentiometric sensors. The potentiometric sensor may include a surface made of lead (Pb), zinc (Zn) and/or vanadium (V). The potentiometric sensor may include a working electrode, the potential of which depends on a concentration of a species to be measured, such as the concentration of the lithium ions.

FIGS. 1C to 1K show various alternative configurations for the actuators 5 and 14. It is to be noted that it is also conceivable that the configurations shown in FIGS. 1A and 1B for the electrode arrangement of the sensor system 6 can be used for the actuators 5 and 14. It is further noted that the configurations for the actuator shown in FIGS. 1C to 1F also represent alternative configurations for the electrode arrangement of the sensor system 6. Moreover, the actuators 5 and 14 may have configurations which are different from each other. Specifically, the actuator 5 may be configured to be partially transmissive for ions which pass from the anode 2 to the cathode 3. This may be achieved by providing the actuator 5 with one or more openings. In contrast thereto, the actuator 14 may be configured as a solid plate or may be configured to be transmissive for air.

Additionally or alternatively, is also conceivable that one or more actuators are implemented in the cathode 3, such as by coating the cathode, by doping the cathode and/or by forming the cathode by means of joining different materials or components.

The actuator which is shown in FIG. 1C has a plurality of holes 15. The actuator includes one or more meshes 16 which span each of the holes. FIG. 1D shows an actuator which is configured as a mesh. The actuators shown in FIGS. 1E and 1F include a plurality of electrodes which are configured as stripes. As is illustrated by FIGS. 1E and 1F, different orientations of individual portions of the actuator relative to the permeable portion may be chosen. The orientations may be chosen depending on the geometry of the permeable portion. By way of example, the orientation of the actuator portions may be adapted to a geometry or shape of the permeable portion.

FIG. 1G shows an actuator which includes a plurality of coils 20 each of which being configured to generate a magnetic field within the pores of the permeable portion. The actuator which is shown in FIG. 1H includes a plurality of coils 22, each of which spanning a circular hole 21 provided in the actuator. The actuators which are illustrated in FIGS. 1J and 1K include a plurality of permanent magnets 23, which are arranged on a mounting structure. The mounting structure may include, for example, a plurality of parallel bars 24, as shown in FIG. 1J, and/or a grid 25, as shown in FIG. 1K. It is conceivable that the mounting structure is configured as an electrode arrangement for generating an electric field.

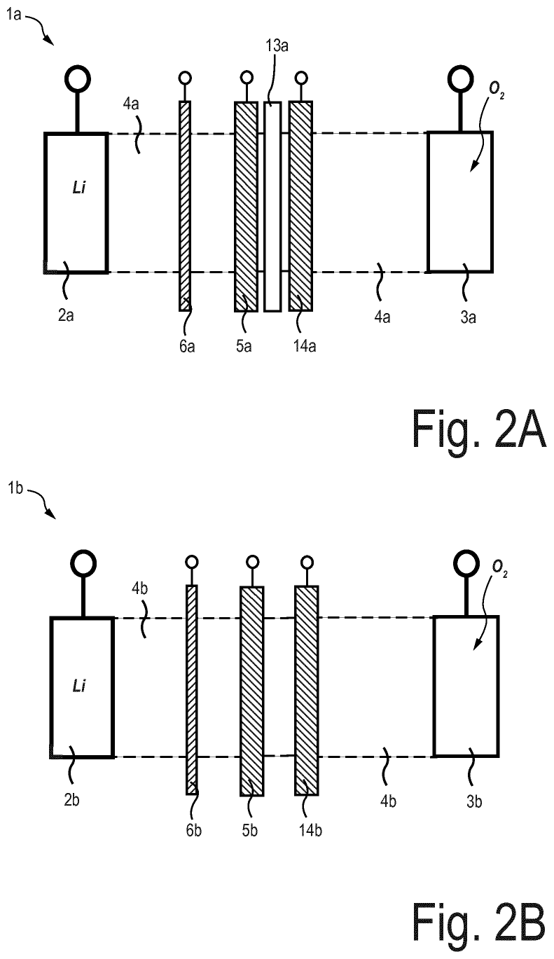

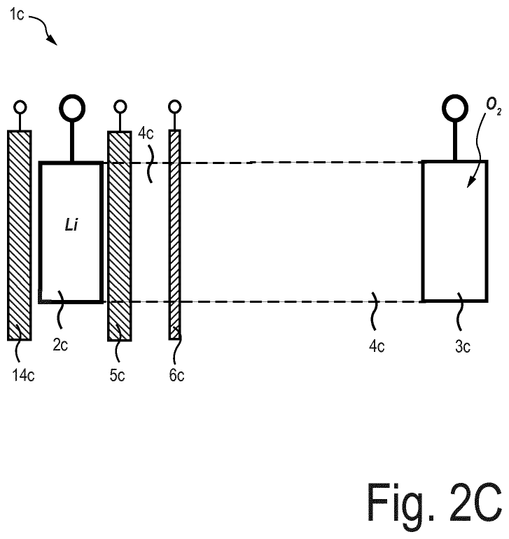

FIGS. 2A to 2C illustrate electrochemical battery cells according to a second to fourth exemplary embodiment. Components, which correspond to components of the battery cell which is shown in FIG. 1 with regard to their composition, their structure and/or function, are designated with the same reference numerals followed by a letter “a” “b” and “c”, respectively.

Each of the electrochemical battery cells 1a, 1b and 1c as shown in FIGS. 2A to 2C, is a lithium (Li)-air battery cell. However, it is noted that it is also possible to obtain the technical effects and advantages described in connection with these embodiments in other battery systems, in particular in other metal-air battery cells, such as sodium (Na)-air, potassium (K)-air, zinc (Zn)-air, magnesium (Mg)-air, and aluminum (Al)-air electrochemical cells or in fuel cells.

The battery cell 1a which is shown in FIG. 2A includes a separator membrane 13a, which is disposed in an ion flow path between the anode 2a and the cathode 3a. The separator membrane 13a is permeable to the lithium ions, thereby forming a permeable portion. In order to prevent clogging of the ion channels within the membrane 13a, two actuators 5a and 14a are provided, each of which being in operative interaction with the membrane 13a for adjusting an ion permeability of the membrane 13a to the ions. For the actuators 5a and 14a, each of the configurations described herein in conjunction with the remaining embodiments, is conceivable.

Additionally or alternatively, is also conceivable that one or more actuators are implemented in the membrane 13a, such as by coating the membrane 13a, by doping the membrane 13a and/or by forming the membrane 13a by means of joining different materials or components.

The operative interaction of the actuators 5a and 14a with the membrane 13a, allows extension of the battery's life-cycle. Although the battery cell 1a of FIG. 2 includes two actuators 5s and 14a, it is conceivable that the battery cell 1a includes one or more than two actuators.

In the battery cell 1b which is illustrated in FIG. 2B, the actuators 5b and 14b are in operative interaction with the electrolyte and configured to adjust a density distribution for each of one or more species contained in the electrolyte.

The operative interaction of the actuators 5b and 14b with the electrolyte allows improvement of the homogeneity of the mixture of electrolyte, oxygen and reactive oxygen. It has been shown that thereby, the battery's life cycle can be increased. Moreover, it has been shown that there are synergistic effects between the carbon electrode and degradation mechanisms within the electrolyte. This can be prevented using the operative interaction of the actuator with the electrolyte.

In the battery cell 1c which is illustrated in FIG. 2C, the actuators 5c and 14c are in operative interaction with the anode 2c. It has been shown that this allows prevention of corrosion at the anode 2c which occurs when the anode 2c reacts with the electrolyte. This problem is particularly severe when lithium is used as anode material due to the highly reducing nature of lithium which leads to the decomposition of most known electrolytes. This leads to insoluble byproducts which further direct contact between the anode and the electrolyte.

Specifically, the operative interaction of the actuators 5c and 14c with the anode 2c and/or adsorbates on the anode 2c cause the adsorbates to be desorbed from the anode 2c. Thereby, a corrosive layer may be removed from the anode 2c. Additionally or alternatively, it has been shown that using the actuators 5c and 14c, it is possible to suppress parasitic chemical reactions between lithium and other components of the battery cell, including O₂, the electrolyte, and the products of the O₂ reduction and electrolyte decomposition. This allows prevention of corrosion of the anode.

Moreover, it has been shown that using one or more actuators in operative interaction with the anode 2c, it is possible to suppress compositional and morphological changes in the solid-electrolyte interface (SEI) between the anode and the electrolyte. Such changes may lead to oxygen invasion to the anode and hence may lead to a decreased performance during charging and discharging cycles.

Additionally or alternatively, is also conceivable that one or more actuators are implemented in the anode 2c, such as by coating the anode 2c, by doping the anode 2c and/or by forming the anode 2c by means of joining different materials or components.

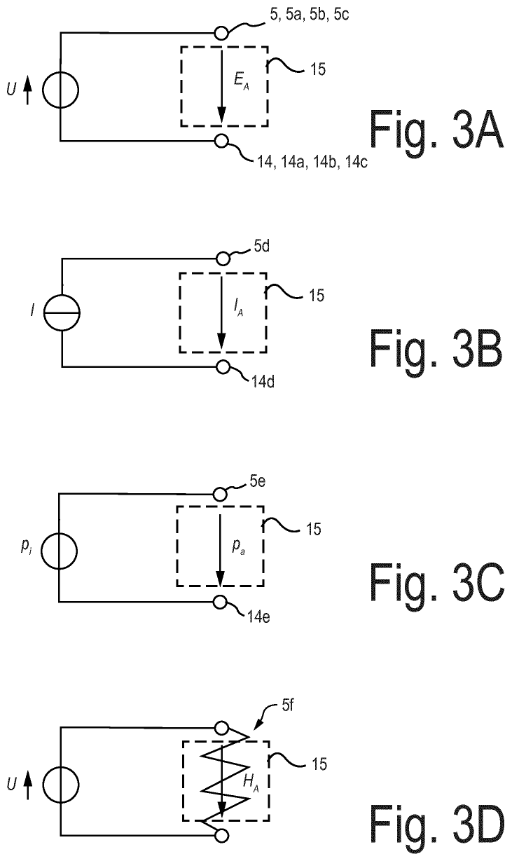

FIGS. 3A to 3D schematically illustrate the actuators of different exemplary embodiments. Each of the actuators may, for example, be implemented in a lithium (Li)-air battery cell. However, it is noted that it is also possible to obtain the technical effects and advantages described in connection with these embodiments in other battery systems, in particular in other metal-air battery cells, such as sodium (Na)-air, potassium (K)-air, zinc (Zn)-air, magnesium (Mg)-air, and aluminum (Al)-air electrochemical cells or in fuel cells.

In the exemplary embodiment which shown in FIG. 3A, the actuator is configured to generate an electric field within the actuated portion 15 as has been described in conjunction with the configurations of the first to fourth exemplary embodiments which are illustrated in FIGS. 1 and 2. The actuated portion 15 may be, for example, a membrane, a cathode, an anode and/or an electrolyte. The actuated portion 15 may be the permeable portion. The permeable portion may be permeable to the ions.

The electric field may be a static electric field or a time-varying electric field. The time-varying electric field may be a pulsed electric field or an oscillatory electric field. In the embodiment which is illustrated in FIG. 3A, the electric field is generated using a first electrode and a second electrode. In the first to fourth exemplary embodiments, the first electrode was designated with reference numbers 5, 5a, 5b and 5c and the second electrode was designated with reference numbers 14, 14a, 14b and 14c. However, it is also conceivable, that only one of the two electrodes or more than two electrodes are used for generating the electric field within the permeable portion 15.

In the fifth exemplary embodiment, which is shown in FIG. 3B, the actuators 5d and 14d are also configured as electrodes, wherein the actuator, is adapted so that an electric current passes through the actuated portion 15. Using the electric current, the iron permeability of the actuated portion 15 to the ions is adjusted. FIG. 3B shows two electrodes 5d, 14d. However, it is also conceivable, that only one of the two electrodes or more than two electrodes are used for passing the current through the actuated portion 15. For the actuators 5d and 14d, the same configurations can be used as has been disclosed in conjunction with the first to fourth exemplary embodiment.

In the sixth exemplary embodiment, which is shown in FIG. 3C, the actuators 5e and 14e are configured to vary a pressure within the actuated portion 15. By way of example, the pressure may be varied by varying the pressure of a liquid electrolyte in which the actuated portion 15 is disposed. The adapted pressure may be continuous or time-varying. The time-varying pressure may be a pulsed pressure variation or an oscillatory pressure variation. It is conceivable that only one or more than two actuators are provided for varying the pressure within the actuated portion 15.

In the seventh exemplary embodiment, which is shown in FIG. 3D, the actuator 5f is configured to generate a magnetic field within the permeable portion 15. The magnetic field may be a constant, and/or a time-varying magnetic field. The time-varying magnetic field may be a pulsed magnetic field and/or an oscillatory magnetic field. The magnetic field may be generated using one or more coils and/or or one or more permanent magnets.

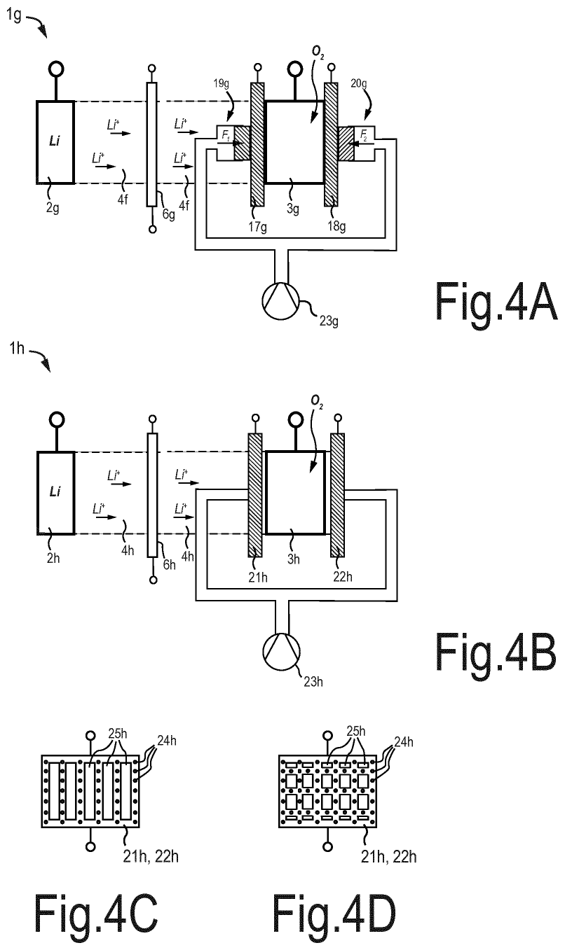

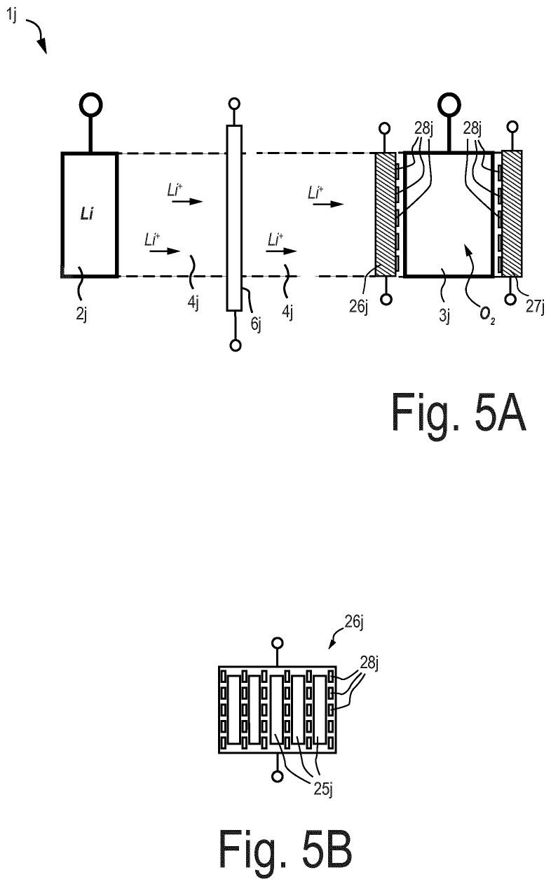

FIG. 4A shows an electrochemical battery cell 1g, according to a eighth exemplary embodiment. Components, which correspond to components of the battery cell, shown in any one of the remaining embodiments with regard to their composition, their structure and/or function are designated with the same reference number, followed by a suffix letter “g”.

The eighth exemplary embodiment is an implementation of the schematic embodiment discussed above with reference to FIG. 3B. In the eighth exemplary embodiment, the actuator includes hydraulic actuators 19g, 20g, each of which being connected to a hydraulic pump 23g for generating opposed compressional forces F₁ and F₂ which are directed from opposite sides toward the actuated portion represented by the porous cathode 3g. Thereby, the pressure within the actuated portion is increased. The forces F₁ and F₂ are transmitted using force transmission plates 17g and 18g, between which the cathode 3g is located. It is conceivable that the force transmission plates 17g and 18g are also configured as electrodes which are used for generating an electric field within the actuated portion or a current, which passes through the actuated portion.

FIG. 4B shows a battery cell 1h according to a ninth exemplary embodiment. Components, which correspond to components of the battery cell of any one of the remaining embodiments with regard to their composition, their structure and/or their function, are designated with the same reference number, followed by a suffix letter “h”.

In the ninth exemplary embodiment, the actuator are configured to exert a hydrodynamic force to the actuated portion which is represented by the porous cathode 3h. The actuator includes two inlet members 21h and 22h. Each of the inlet members 21h and 22h is in fluid communication with a pump 23h. Further, each of the inlet members 21h and 22h is provided with a plurality of inlet ports for injecting a liquid, such as water or a solvent in a direction toward the actuated portion which is represented by the cathode 3h. It is also conceivable that additionally or alternatively, the actuator is configured to exert an aerodynamic force on the actuated portion. By way of example, the pump 23h may be configured to generate compressed air, which is injected into the battery cell 1h using the inlet ports provided in the inlet members 21h and 22h.

FIGS. 4C and 4D show exemplary configurations for the inlet member 21h and 22h, of the actuator in the ninth exemplary embodiment illustrated in FIG. 4B. Each of FIGS. 4C and 4D shows a side view of the respective inlet member, as seen from the cathode 3h. Each of the inlet members 21h and 22h includes a plurality of inlet ports 24h, through which a liquid and or a gas is injected into the battery cell 1h. Furthermore, at least the member 21h has a plurality of opening 25h, allowing the ions to pass through the inlet member 21h to reach the cathode 3h.

FIG. 5A is a schematic illustration of a battery cell according to a tenth exemplary embodiment. Components, which correspond to components of the battery cells of any one of the remaining embodiments with regard to their composition, their structure and/or their function, are designated with the same reference number, followed by a suffix letter “j”.

The actuator of the battery cell 1j according to the tenth exemplary embodiment is configured to couple acoustic energy into the actuated portion, which in the tenth exemplary embodiment is represented by the porous cathode 3j. The actuator of the battery cell 1j includes mounting structure 26j and 27j on which and one or more mechanical transducers 28j are mounted. In the shown exemplary embodiment, the mechanical transducers 28j are configured as piezo-electric transducers. It is also conceivable that surface portions of the mounting structures 26j and 27j are coated using a piezo-active material.

The mechanical transducers 28j are configured so that application of a voltage to the mechanical transducers 28j cause the mechanical transducers 28j to extend toward the permeable portion, i.e porous cathode 3j so that acoustic energy is directed toward the permeable portion.

FIG. 5B shows a view of a side of the mounting structure 26j of the battery cell 1j, that faces the cathode 3j. The mounting structure 26j has the plurality of mechanical transducers 28j mounted thereon. The mounting structure 26j further includes a plurality of openings 25j allowing the ions to pass through the mounting structure 26j. The mounting structure 27j may have the same or a similar configuration as the mounting structure 26j or may be configured without openings 25j.

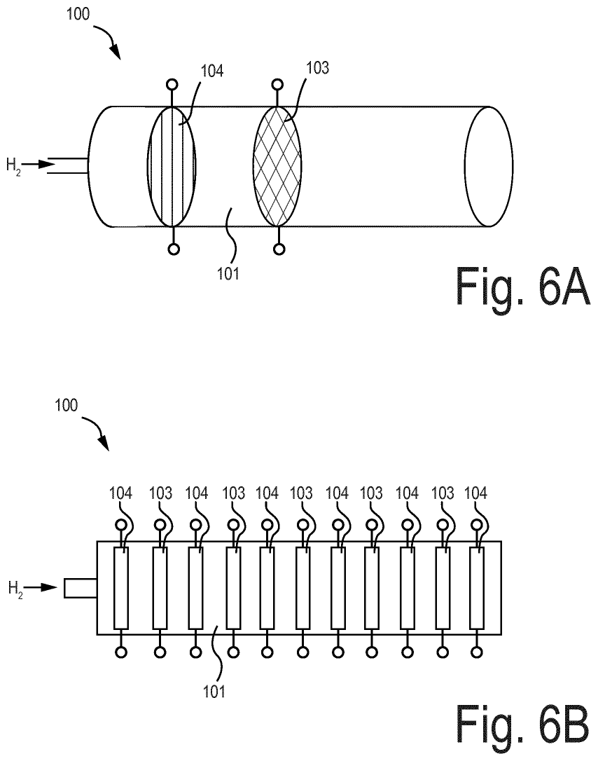

FIG. 6A shows an exemplary embodiment of a reversible solid-state storage 100 according to an exemplary embodiment. The exemplary solid-state storage 100 is configured to store hydrogen. However, alternatively or additionally, it is conceivable that the solid-state storage 100 is configured to store other species, such as oxygen.

The solid-state storage 100 includes a permeable portion, configured to allow the storable chemical species to permeate into the permeable portion. In the exemplary embodiment, the permeable portion represents at least a portion of the storage media in which the storable chemical species is stored. However, it is also conceivable that the permeable portion is a component of the solid-state storage 100 which does not function as a storage medium, such as a membrane.

Materials for the storage media include but are not limited to NaAlH₄, LiAlH₄, FeTiH_{1,7}, LaNi₅H₆, Mg₂(Ni_{0.5},Cu_{0.5})H₄, MgH₂, LiBH₄, Ca(BH₄)₂, KBH₄, NaBH₄ and graphene.

In the shown exemplary embodiment, the permeable portion is a porous material. The pore size of the permeable portion may be within the same range, as given above in connection with the electrochemical battery cell.

As is shown in FIG. 6A, the solid-state storage 100 further comprises an actuator 103, which is in operative interaction with the permeable portion and which is configured for adjusting a permeability of the permeable portion to the storable chemical species 100. As is further shown in FIG. 6A, the solid-state storage 100 further includes a sensor system 104, which is configured to measure one or more operational parameters of the solid-state storage 100. For the sensor system 104, the same or basically the same configurations are conceivable as described above in conjunction with the exemplary embodiments of the electrochemical battery cell.

The solid-state storage 100 further comprises a controller which is not shown in FIG. 6A and which is configured to control the actuator 103 depending on sensor output generated by the sensor system 103.

FIG. 6B shows the arrangement of the actuators 103 and the sensors 104 in the exemplary solid-state storage 100 in greater detail. As can be seen from FIG. 6B, the solid-state storage 100 includes a plurality of sensor systems 104 and a plurality of actuators 103. The sensor systems 104 and the actuators 103 are arranged in an alternating fashion along an axis. It has been shown that this configuration allows for an improved control of the permeability of the permeable portion.

It has been shown that advantageous configurations of the actuator 103 correspond to the configurations which have been described above in connection with the embodiments of the electrochemical battery cell 1.

Specifically, the actuator 103 may be configured to generate an electric and/or magnetic field which penetrates into the permeable portion.

The electric field may be a constant or time-varying electric field. The time-varying electric field may be a pulsed electric field or an oscillatory electric field. The magnetic field may be a constant or time-varying magnetic field. The time-varying magnetic field may be a pulsed magnetic field or an oscillatory magnetic field. The actuator 103 may include one or a plurality of electrodes and/or coils for generating the electric and/or magnetic field.

Additionally or alternatively, the actuator 103 may be configured to cause an electric current to pass through the permeable portion of the reversible solid-state storage 100. The actuator 103 may be configured so that the electric current, adjusts the permeability of the permeable portion to the storable chemical species 100. The electric current may be a constant or time-varying electric current. The time-varying electric current may be a pulsed electric current or an oscillatory electric current.

Additionally or alternatively, the actuator 103 may include one or more mechanical transducers for coupling an acoustic energy into the permeable portion. Additionally or alternatively, the actuator 103 may be configured to exert a mechanic, hydrogen and/or aerodynamic force on the permeable portion. The force may be a constant or time-varying force. The time-varying force may be a pulsed force or an oscillatory force.

Additionally or alternatively, the actuator 103 may be configured vary a pressure within the permeable portion. The adapted pressure may be constant or time-varying. The time-varying pressure may be a pulsed pressure variation or an oscillatory pressure variation.

It has been shown that thereby, a reversible solid-state storage 100 can be obtained which has an increased life-cycle and reduced maintenance costs.

1. An apparatus configured as an electrochemical battery cell, comprising:
an anode, a cathode, and an electrolyte which is configured to allow ions to travel between the anode and the cathode;
an actuator,
wherein
(a) the actuator configured to adjust a parameter of an electrochemical reaction in which the actuator and/or an actuated portion of the battery cell is chemically involved; and/or
(b) the actuator and/or the actuated portion is a permeable portion of the battery cell which is configured to allow the ions to permeate into the permeable portion, wherein the actuator is configured to adjust an ion permeability of the permeable portion to the ions;
wherein the actuated portion of the battery cell is in operative interaction with the actuator.

2. The apparatus of claim 1, wherein the actuator is configured to desorb one or more adsorbed species from the actuator and/or the actuated portion.

3. The apparatus of claim 1, wherein the cathode, the anode the electrolyte and/or a separator membrane which is disposed in a flow path of the ions between the anode and the cathode, comprise the actuator and/or the actuated portion.

4. The apparatus of claim 1, wherein the permeable portion comprises a porous material, wherein the ion permeability of the permeable portion is at least partially provided by pores of the porous material.

5. The apparatus of claim 1, wherein the ion permeable portion is at least a portion of the cathode which is configured as a gas diffusion cathode.

6. The apparatus of claim 1, wherein the permeable portion comprises a plurality of channels;
wherein a permeability of the channels determine the permeability of the permeable portion.

7. The apparatus of claim 6, wherein the actuator configured to adjust the permeability of the permeable portion by physically modifying at least a portion of the channels.

8. The apparatus of claim 6, wherein the actuator is configured to interact with one or more adsorbed and/or entrapped species within the channels for adjusting a chemical reaction activity within the channels.

9. The apparatus of claim 1, wherein the electrochemical cell is a metal-air electrochemical cell.

10. The apparatus of any one of claim, further comprising a controller and a sensor system, the sensor system is being configured to measure at least one operational parameter of the battery cell;
wherein the actuator is controlled by the controller depending on sensor output of the sensor system.

11. The apparatus of claim 10, wherein tho sensor system is configured for measurement of a charge density and/or a charge flux density within the electrolyte.

12. The apparatus of claim 10, wherein the sensor system comprises a resistive sensor, a capacitive sensor and/or a potentiometric sensor.

13. The apparatus of claim 1, wherein the actuator is configured to generate an electric field, a magnetic field and/or an electric current which adjust the parameter of the electrochemical reaction and/or the permeability.

14. The apparatus of claim 1, wherein the actuator comprises one or more mechanical transducers for coupling acoustic energy into the actuated portion.

15. The apparatus of claim 1, wherein the actuator is configured to exert a mechanic, hydrodynamic and/or aerodynamic force on the actuated portion.

16. An apparatus configured as a solid-state storage for at least one chemical species to be stored, the solid-state storage comprising:
a permeable portion which is configured to allow the chemical species to permeate through the permeable portion for storing or retrieving the chemical species from the solid-state storage; and
an actuator which is at least a portion of the permeable portion and/or which is in operative interaction with the permeable portion for adjusting a permeability of the permeable portion to the chemical species.

17. The apparatus of claim 16, wherein the permeable portion is at least a portion of a storage medium in which the chemical species is stored.

18. The apparatus of claim 16, wherein the chemical species to be stored is hydrogen.

19. The apparatus of claim 16, wherein the permeable portion comprises a porous material, wherein a permeability of the permeable portion to the chemical species to be stored is at least partially provided by pores of the porous material.

20. The apparatus of claim 16, wherein the permeable portion comprises a plurality of channels;
wherein a permeability of the channels at least partially determine the permeability of the permeable portion to the chemical species to be stored.

21. The apparatus of claim 20, wherein the actuator is configured to adjust the permeability by physically modifying at least a portion of the channels for performing the adjustment of the permeability of the permeable portion to the chemical species to be stored.

22. The apparatus of claim 20, wherein the actuator is configured to interact with one or more adsorbed and/or entrapped species within the channels for adjusting a permeability of the permeable portion to the chemical species to be stored.

23. The apparatus of claim 16, further comprising a controller and a sensor system which is configured to measure an operational parameter of the solid-state storage;
wherein the actuator is controlled by the controller depending on sensor signals output of the sensor system.

24. The apparatus of claim 1, wherein the actuator is configured to generate an electric and/or magnetic field which penetrates into the permeable portion.

25. The apparatus of claim 16, wherein the actuator comprises one or more mechanical transducers for coupling acoustic energy into the permeable portion.

26. The apparatus of claim 16, wherein the actuator is configured to exert a mechanic, hydrodynamic and/or aerodynamic force on the permeable portion.

27. An apparatus configured as an electrochemical battery cell, comprising:
an anode, a cathode, and an electrolyte configured to allow ions to travel between the anode and the cathode; and
an actuator which is in operative interaction with the electrolyte and configured to adjust a density distribution for each of one or more species contained in the electrolyte.

28. The apparatus of claim 27, wherein the actuator is configured to adjust the density distribution using
a continuous, pulsed and/or oscillating electric field,
a continuous, pulsed and/or oscillating magnetic field and/or
a continuous, pulsed and/or oscillating current.

29. The apparatus of claim 27, wherein the actuator configured to adjust the density distribution using mechanical transducers which are configured to couple acoustic energy into the electrolyte.

30. The apparatus of claim 27, wherein the actuator is configured to adjust the density distribution using a mechanic, hydrodynamic and/or aerodynamic force which is exerted on the electrolyte using the actuator.
